(19) United States
(12) Patent Application Publication
(10) Pub. No.: US 2008/0240051 A1
(43) Pub. Date: Oct. 2, 2008

(54) WIRELESS DIAGNOSTIC MONITORING SYSTEM AND METHOD FOR MONITORING WIRELESS DEVICES

(76) Inventors: Louis L. Nagy, Warren, MI (US); Francis E. Szczublewski, Macomb, MI (US); Laci J. Jalics, Ray, MI (US); Mark K. Krage, Troy, MI (US); Andrzej Pawlak, Rochester Hills, MI (US)

Correspondence Address: DELPHI TECHNOLOGIES, INC., M/C 480-410-202, PO BOX 5052, TROY, MI, 48007, US

(21) Appl. No.: 11/694,372

(22) Filed: Mar. 30, 2007

(51) Int. Cl. H04Q 7/24

(52) U.S. Cl. 370/338

(57) ABSTRACT

A wireless diagnostic monitoring system and a method for monitoring wireless devices are provided. The system includes at least one wireless device having a first RF transceiver and a first microprocessor operably coupled to the first RF transceiver. The wireless device is configured to transmit an RF signal having a diagnostic message having operational status information associated with the wireless device and a unique identifier identifying the wireless device. The system further includes a monitoring device having a second RF transceiver and a second microprocessor operably coupled to the second RF transceiver. The second RF transceiver is configured to receiver the RF signal. The second microprocessor is configured to determine an operational task to perform based on the operational status information. The second microprocessor is further configured to store data associated with the operational task in a memory device.

### BACKGROUND

The present application is directed to a wireless diagnostic monitoring system and a method for monitoring wireless devices.

Many electrical/electronic devices require periodic or infrequent maintenance, such as replacing or recharging batteries therein. While some battery replacements for devices (e.g., smoke detectors) can be scheduled, others devices (e.g., remote controllers, battery powered thermostats) require replacement at random times. In addition, some devices require some form of monitoring. For example, a garage door can be monitored to determine whether it has been left open or not, and a dishwasher can be monitored to determine whether it has completed its wash cycle. Also, an oven can be monitored to determine whether it has been preheated.

Keeping track of all such devices and stocking an appropriate battery size before the device has impaired operation can be a challenge for individuals who have many devices and systems. In addition, the monitoring required by many devices and systems can be burdensome to individuals.

Accordingly, the inventors herein have recognized a need for an improved wireless diagnostic monitoring system to determine an operational status of wireless devices.

### SUMMARY OF THE INVENTION

A wireless diagnostic monitoring system in accordance with an exemplary embodiment is provided. The system includes at least one wireless device having a first RF transceiver and a first microprocessor operably coupled to the first RF transceiver. The wireless device is configured to transmit an RF signal having a diagnostic message having operational status information associated with the wireless device and a unique identifier identifying the wireless device. The system further includes a monitoring device having a second RF transceiver and a second microprocessor operably coupled to the second RF transceiver. The second RF transceiver is configured to receive the RF signal. The second RF transceiver is further configured to send the diagnostic message to the second microprocessor. The second microprocessor is configured to determine an operational task to be performed based on the operational status information. The second microprocessor is further configured to store data associated with the operational task in a memory device.

A method for monitoring at least one wireless device utilizing a monitoring device in accordance with another exemplary embodiment is provided. The wireless device has both a first RF transceiver and a first microprocessor operably coupled to the first RF transceiver. The monitoring device has both a second RF transceiver and a second microprocessor operably coupled to the second RF transceiver. The method includes transmitting an RF signal from the first transceiver of the wireless device having a diagnostic message having operational status information associated with the wireless device and a unique identifier identifying the wireless device. The method further includes receiving the RF signal utilizing the second RF transceiver of the monitoring device and sending the diagnostic message to the second microprocessor. The method further includes determining an operational task to be performed based on the operational status information utilizing the second microprocessor of the monitoring device. The method further includes storing data associated with the operational task in a memory device, utilizing the second microprocessor.

A method for monitoring a location of a wireless device in accordance with another exemplary embodiment is provided. The wireless device is configured to transmit RF signals. The method includes transmitting a first RF signal from the wireless device at a first location in a building. The first RF signal has a unique identifier identifying the wireless device. The method further includes receiving the first RF signal at a first monitoring device. The first monitoring device is configured to receive RF signals in a first region of the building. The first location is in the first region. The method further includes moving the wireless device to a second location in the building. The method further includes transmitting a second RF signal from the wireless device at the second location in the building. The second RF signal has the unique identifier identifying the wireless device. The method further includes receiving the second RF signal at a second monitoring device. The second monitoring device is configured to receive RF signals in a second region of the building. The second location is in the second region. The method further includes sending a message from the second monitoring device through a communication bus to the first monitoring device indicating that the wireless device having the unique identifier is in the second region. The method further includes receiving the message at the first monitoring device and storing data indicating the location of the wireless device in a memory device.

### BRIEF DESCRIPTION OF THE DRAWINGS

FIG. 1 is a schematic of a wireless diagnostic monitoring system having a monitoring device and first and second wireless devices in accordance with an exemplary embodiment;

FIGS. 2-4 are flowcharts of a method for monitoring a wireless device utilizing the wireless diagnostic monitoring system of FIG. 1;

FIG. 5 is a schematic of a monitoring device communicating with a plurality of wireless devices;

FIG. 6 is a schematic of a networked system having a plurality of monitoring devices communicating with a moving wireless device; and

FIG. 7 is a flowchart of a method for monitoring a location of a moving wireless device.

### DETAILED DESCRIPTION OF EXEMPLARY EMBODIMENTS

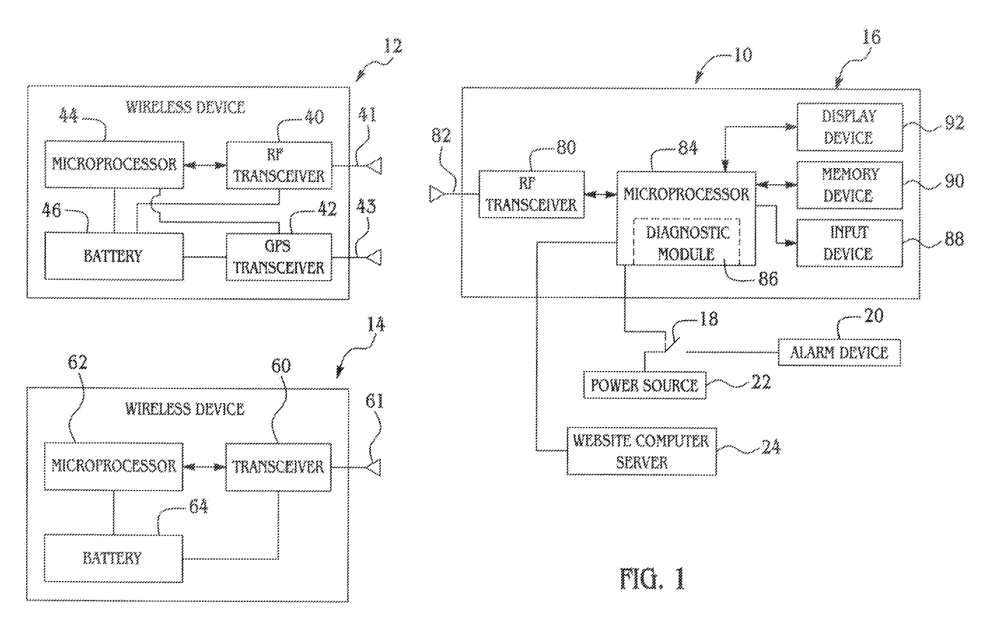

Referring to FIG. 1, a wireless diagnostic monitoring system 10 is illustrated. The wireless diagnostic system 10 includes a wireless device 12, a wireless device 14, a monitoring device 16, a relay contact 18, an alarm device 20, a power source 22, and a website computer server 24. It should be noted that although only two wireless devices are shown in the system 10, in an alternative embodiment a plurality of additional wireless devices could be utilized.

The wireless device 12 is provided to transmit operational status information to the monitoring device 16. The wireless device 12 includes an RF transceiver 40, an antenna 41, a GPS transceiver 42, an antenna 43, a microprocessor 44, and a battery 46. During operation, the microprocessor 44 generates a control signal to induce the RF transceiver 40 to transmit an RF signal via the antenna 41 having a diagnostic message having (i) operational status information associated with the wireless device 12, (ii) a unique identifier identifying the wireless device 12, and (iii) a GPS coordinate of the wireless device 12. The operational status of the wireless device 12 can include any information that describes the operation of the wireless device 12. For example, operational status information can indicate a low battery charge condition or a desired battery charge condition of the wireless device 12. It should be noted that the GPS coordinate of the wireless device 12 is received by the microprocessor 44 from the GPS transceiver 42 which communicates with at least three GPS satellites. The battery 46 outputs an operational voltage to the microprocessor 44, the RF transceiver 40, and the GPS transceiver 42.

The wireless device 14 is provided to transmit operational status information to the monitoring device 16. The wireless device 14 includes an RF transceiver 60, an antenna 61, a microprocessor 62, and a battery 64. During operation, the microprocessor 62 generates a control signal to induce the RF transceiver 60 to transmit an RF signal via the antenna 61 having a diagnostic message having (i) operational status information associated with the wireless device 12, and (ii) a unique identifier identifying the wireless device 12. The battery 64 outputs an operational voltage to the microprocessor 62 and the RF transceiver 60.

The monitoring device 16 is provided to monitor an operational status of the wireless devices 12, 14. The monitoring device 16 includes an RF transceiver 80, ad antenna 82, a microprocessor 84, an input device 88, the memory device 90, and a display device 92.

The RF transceiver 80 is provided to receiver RF signals via the antenna 82 from the wireless device 12. In one exemplary embodiment, the antenna 82 is a Self-Structuring Antenna (SSA) capable of providing varied RF beam patterns. The RF signal from the wireless device 12 has a diagnostic message having operational status information associated with the wireless device 12, a unique identifier identifying the wireless device 12, and the GPS location of the wireless device 12. The RF transceiver 80 sends the operational status information associated with the wireless device 12, the unique identifier identifying the wireless device 12, and the GPS location of the wireless device 12 to the microprocessor 84. The microprocessor 84 is configured to determine an operational task to be performed based upon the operational status information associated with the wireless device 12, utilizing a diagnostic software module 86. The microprocessor 84 is further configured to store data associated with the operational task in the memory device 90.

The RF transceiver 80 is further provided to receiver RF signals via the antenna 82 from the wireless device 14. The RF signal from the wireless device 14 has a diagnostic message having operational status information associated with the wireless device 14 and a unique identifier identifying the wireless device 14. The RF transceiver 80 sends the operational status information associated with the wireless device 14 and the unique identifier identifying the wireless device 14 to the microprocessor 84. The microprocessor 84 is configured to determine an operational task to be performed based upon the operational status information associated with the wireless device 14, utilizing a diagnostic software module 86. The microprocessor 84 is further configured to store data associated with the operational task in the memory device 90.

The microprocessor 84 is further configured to control an alarm device 20. In particular, when the microprocessor 84 makes a determination that the operational task to be performed is to activate an alarm device, the microprocessor 84 generates a control signal for the electrical contact 18. The control signal induces the electrical contact 18 to have a closed operational condition and an operational voltage from the power source 22 is applied to the alarm device 20 to activate the alarm device 20. Further, the microprocessor 84 is configured to send a message to the web site computer server 24 having instructions for updating a website.

The input device 88 is provided to allow a user to input data into the monitoring device 16. The input device 88 is operably coupled to the microprocessor 84.

The display device 92 is provided to display diagnostic messages received from the wireless devices. The display device 92 is operably coupled to the microprocessor 84. Although the method will be explained utilizing wireless device 12, it should be understood that a similar method could be utilized to monitor the wireless device 14.

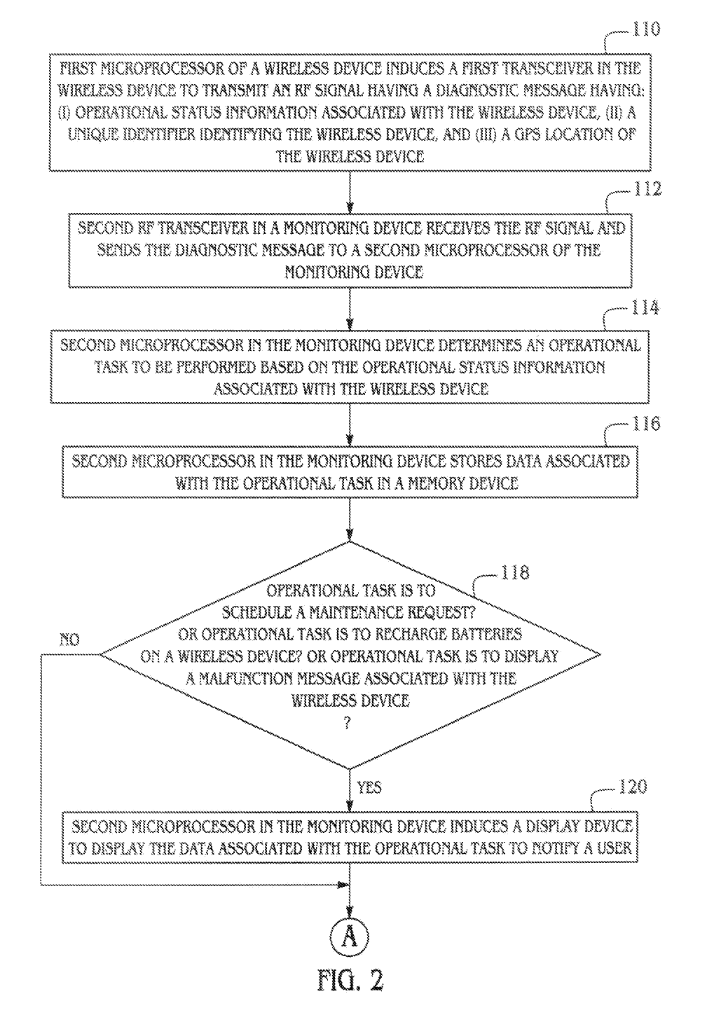

Referring to FIGS. 2-4, a flowchart of a method for monitoring an operational status of a wireless device will now be explained.

At step 110, the microprocessor 44 of the wireless device 12 induces the RF transceiver 40 in the wireless device 12 to transmit an RF signal having a diagnostic message having: (i) operational status information associated with the wireless device 12, (ii) a unique identifier identifying the wireless device 12, and (iii) a GPS location of the wireless device 12.

At step 112, the RF transceiver 80 in the monitoring device 16 receives the RF signal and sends the diagnostic message to the microprocessor 84 of the monitoring device 16.

At step 114, the microprocessor 84 in the monitoring device 16 determines an operational task to be performed based on the operational status information associated with the wireless device 12.

At step 116, the microprocessor 84 in the monitoring device 16 stores data associated with the operational task in the memory device 90.

At step 118, the microprocessor 84 in the monitoring device 16 makes a determination as to whether (i) the operational task is to schedule a maintenance request, or (ii) the operational task is to recharge batteries on the wireless device 12, or (iii) the operational task is to display a malfunction message associated with the wireless device 12. If the value of step 118 equals “yes”, the method advances to step 120. Otherwise, the method advances to step 122.

At step 120, the microprocessor 84 in the monitoring device 16 induces a display device 92 to display the data associated with the operational task to notify a user. After step 120, the method advances to step 122.

At step 122, the microprocessor 84 in the monitoring device 16 makes a determination as to whether the operational task is to activate an alarm. If the value of step 122 equals “yes”, the method advances to step 124. Otherwise, the method advances to step 126.

At step 124, the microprocessor 84 in the monitoring device 16 generates a control signal to activate the relay contact 18 which activates the alarm device 20. After step 124, the method advances to step 126.

At step 126, the microprocessor makes a determination as to whether the operational task is to call a user. If the value of step 126 equals “yes”, the method advances to step 128. Otherwise, the method advances to step 130.

At step 128, the microprocessor 84 in the monitoring device 16 induces the RF transceiver 80 in the monitoring device 16 to transmit an RF signal having the data associated with the operational task for initiating to a text page call to a user. After step 128, the method advances to step 130.

At step 130, the microprocessor 84 in the monitoring device 16 makes a determination as to whether the operational task is to activate an operational feature of the wireless device 12. If the value of step 130 equal “yes”, the method advances to step 132. Otherwise, the method advances to step 136.

At step 132, the microprocessor 84 in the monitoring device 16 induces the RF transceiver 80 to transmit another RF signal having instructions for activating the operational feature of the wireless device 12. After step 132, the method advances to step 134.

At step 134, the RF transceiver 40 in the wireless device 12 receives the other RF signal and the microprocessor 44 in the wireless device 12 activates the operational feature of the wireless device 12 based on the instructions in the RF signal. After step 134, the method advances to step 136.

At step 136, the microprocessor 84 in the monitoring device 16 makes a determination as to whether the operational task is to update a website. If the value of step 136 equals “yes”, the method advances to step 138. Otherwise, the method is exited.

At step 138, the microprocessor 84 in the monitoring device 16 sends a message to the website computer server 24 having website instructions for updating a website.

At step 140, the website computer server 24 updates the website based on the website instructions in the message. After step 140, the method is exited.

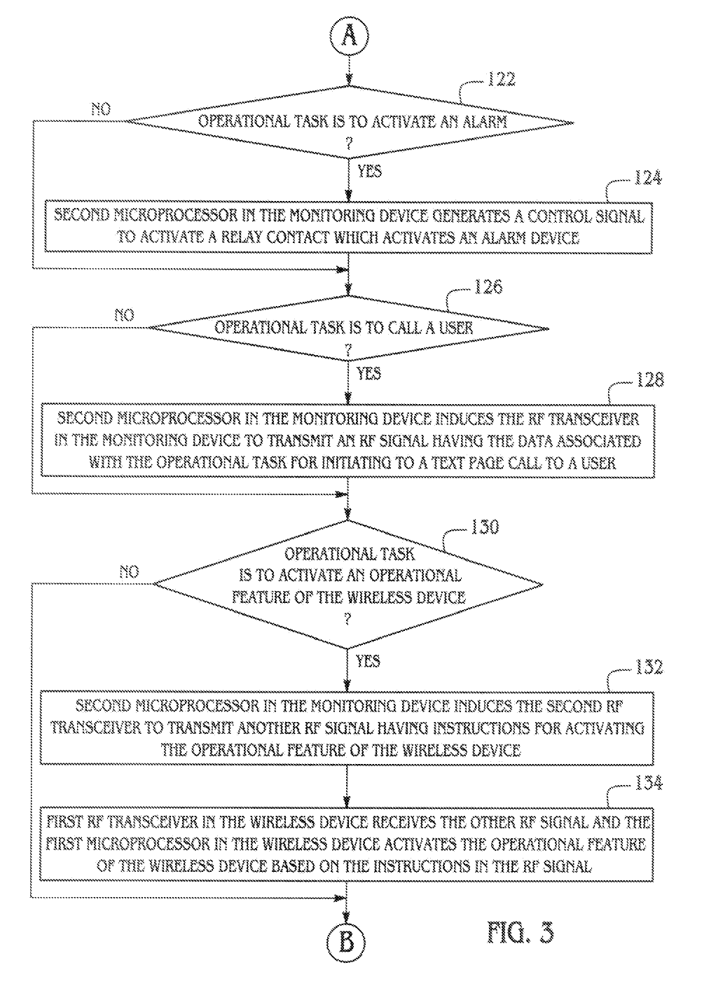

Referring to FIG. 5, a wireless diagnostic monitoring system 148 in accordance with another exemplary embodiment is illustrated. The system 148 includes the monitoring device 16 and wireless devices 150, 152, 154 and 156. The wireless device 150 comprises a cellular phone. The wireless device 152 comprises a keyless entry transmitter for a vehicle. The wireless device 154 comprises an oven and the wireless device 156 comprises a garage door opener. The wireless devices 150, 152, 154, 156 transmit RF signals that have diagnostic messages having operational status information and unique identifiers to the monitoring device 16. For example, the cellular phone 150 can transmit an RF signal having a diagnostic message indicating an operational status of “on” to the monitoring device 16. Further, for example, the keyless entry transmitter 152 can transmit an RF signal having a diagnostic message indicating an operational status of “on” to the monitoring device 16. Further, for example, the oven 154 can transmit an RF signal having a diagnostic message indicating an operational status of “off” to the monitoring device 16. Further, for example, the garage door opener 156 can transmit an RF signal having a diagnostic message indicating an operational status of “open” to the monitoring device 16. The monitoring device 16 utilizes a Self-Structuring Antenna 82 for receiving RF signals and transmitting RF signals.

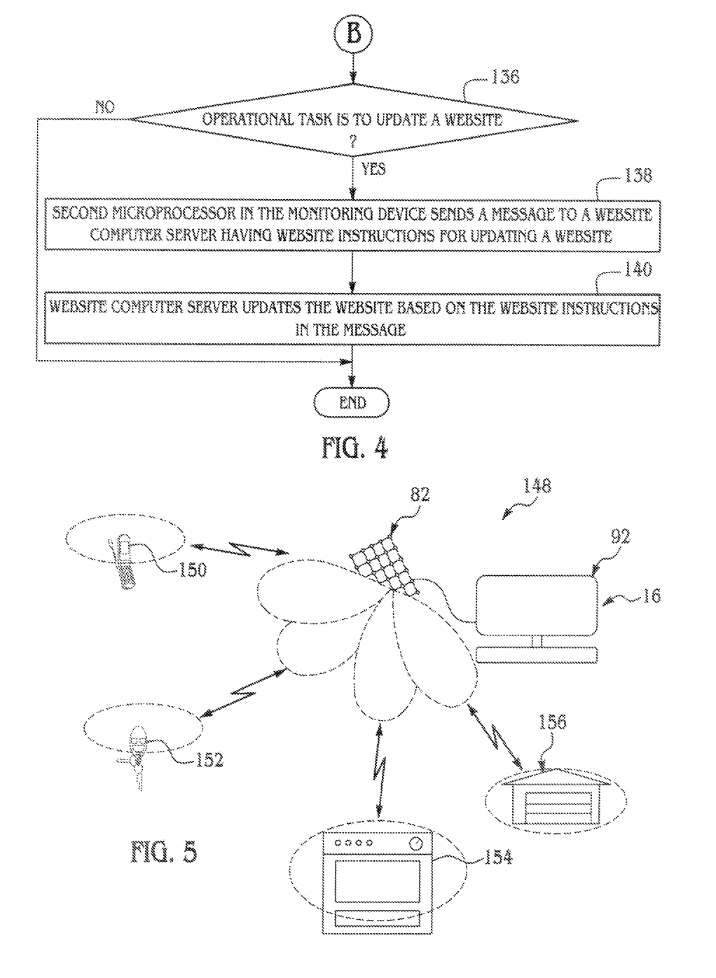

Referring to FIG. 6, a networked system 169 having monitoring devices 16, 170, a communication bus 174, and the wireless device 12 is illustrated. The monitoring device 16 is configured to receive RF signals from the wireless device 12 when the wireless device 12 is in a region 178 within a building. The monitoring device 170 is configured to receive RF signals from the wireless device 12 when the wireless device 12 is in a region 180 within the building. The communication bus 174 allows the monitoring device 16 to operably communicate with the monitoring device 170.

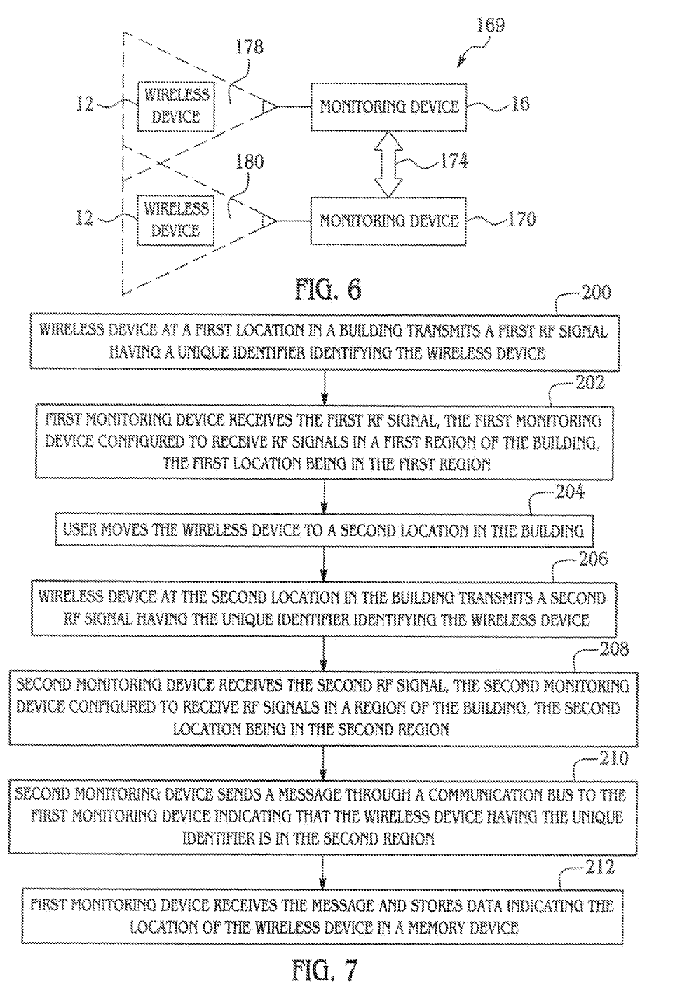

Referring to FIG. 7 a flowchart of a method for monitoring a location of a moving wireless device will now be explained.

At step 200, the wireless device 12 at a first location in a building transmits a first RF signal having a unique identifier identifying the wireless device 12.

At step 202, the monitoring device 16 receives the first RF signal. The monitoring device 16 is configured to receive RF signals in a first region of the building. The first location is in the first region.

At step 204, a user moves the wireless device 12 to a second location in the building.

At step 206, the wireless device 12 at the second location in the building transmits a second RF signal having the unique identifier identifying the wireless device 12.

At step 208, the monitoring device 170 receives the second RF signal. The monitoring device 170 is configured to receive RF signals in a second region of the building. The second location is in the second region.

At step 210, the monitoring device 170 sends a message through the communication bus 174 to the monitoring device 16 indicating that the wireless device 12 having the unique identifier is in the second region.

At step 212, the monitoring device 170 receives the message and stores data indicating the location of the wireless device 12 in the memory device 90. After step 212, the method is exited.

The wireless diagnostic monitoring system and the method for monitoring wireless devices provide a substantial advantage over other systems and methods. In particular, the system and method provide a technical effect of utilizing a monitoring device that receives RF signals from wireless devices having diagnostic messages with operational status information (e.g., low battery charge condition) associated with wireless devices, wherein the monitoring device determines operational tasks to be performed based upon the operational status information.

While embodiments of the invention are described with reference to the exemplary embodiments, it will be understood by those skilled in the art that various changes may be made and equivalents may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. A wireless diagnostic monitoring system, comprising:
at least one wireless device having a first RF transceiver and a first microprocessor operably coupled to the first RF transceiver, the wireless device configured to transmit an RF signal having a diagnostic message having operational status information associated with the wireless device and a unique identifier identifying the wireless device; and
a monitoring device having a second RF transceiver and a second microprocessor operably coupled to the second RF transceiver, the second RF transceiver configured to receive the RF signal, the second RF transceiver further configured to send the diagnostic message to the second microprocessor, the second microprocessor configured to determine an operational task to perform based on the operational status information, the second microprocessor further configured to store data associated with the operational task in a memory device.

2. The wireless diagnostic monitoring system of claim 1, wherein the operational status is one of a low battery charge condition and a desired battery charge condition.

3. The wireless diagnostic monitoring system of claim 1, wherein the operational task comprises at least one of scheduling a maintenance request for the wireless device, calling a user, updating a website or a mobile device, recharging batteries of the wireless device, activating an operational feature of the wireless device, displaying a malfunction message associated with the wireless device, toggling a relay, actuating an actuator, and activating an alarm device.

4. The wireless diagnostic monitoring system of claim 1, wherein the second microprocessor of the monitoring device is further configured to induce a display device to display the data associated with the operational task.

5. The wireless diagnostic monitoring system of claim 1, wherein the second microprocessor of the monitoring device is configured to determine a location of the wireless device based on a parameter of the RF signal.

6. A method for monitoring at least one wireless device utilizing a monitoring device, the wireless device having both a first RF transceiver and a first microprocessor operably coupled to the first RF transceiver, the monitoring device having both a second RF transceiver and a second microprocessor operably coupled to the second RF transceiver, the method comprising:
transmitting an RF signal from the first transceiver of the wireless device having a diagnostic message having operational status information associated with the wireless device and a unique identifier identifying the wireless device; and
receiving the RF signal utilizing the second RF transceiver of the monitoring device and sending the diagnostic message to the second microprocessor;
determining an operational task to perform based on the operational status information utilizing the second microprocessor of the monitoring device; and
storing data associated with the operational task in a memory device, utilizing the second microprocessor.

7. The method of claim 6, wherein the operational status is one of a low battery charge condition and a desired battery charge condition.

8. The method of claim 6, wherein the operational task comprises at least one of scheduling a maintenance request for the wireless device, calling a user, updating a website or a mobile device, recharging batteries of the wireless device, activating an operational feature of the wireless device, displaying a malfunction message associated with the wireless device, toggling a relay, actuating an actuator, and activating an alarm device.

9. The method of claim 6, further comprising inducing a display device to display the data associated with the operational task, utilizing the second microprocessor operably coupled to the display device.

10. The method of claim 6, further comprising determining a location of the wireless device based on a parameter of the RF signal, utilizing the first microprocessor.

11. A method for monitoring a location of a wireless device, the wireless device configured to transmit RF signals, the method comprising:
transmitting a first RF signal from the wireless device at a first location in a building, the first RF signal having a unique identifier identifying the wireless device;
receiving the first RF signal at a first monitoring device, the first monitoring device configured to receive RF signals in a first region of the building, the first location being in the first region;
moving the wireless device to a second location in the building;
transmitting a second RF signal from the wireless device at the second location in the building, the second RF signal having the unique identifier identifying the wireless device;
receiving the second RF signal at a second monitoring device, the second monitoring device configured to receive RF signals in a second region of the building, the second location being in the second region;
sending a message from the second monitoring device through a communication bus to the first monitoring device indicating that the wireless device having the unique identifier is in the second region; and
receiving the message at the first monitoring device and storing data indicating the location of the wireless device in a memory device.
